(19) United States
(12) Patent Application Publication
(10) Pub. No.: US 2014/0156557 A1
(43) Pub. Date: Jun. 5, 2014

(54) Providing a Simulation Service by a Cloud-Based Infrastructure

(71) Applicants: Jun Zeng, Sunnyvale, CA (US); Jun Li, Mountain View, CA (US)

(72) Inventors: Jun Zeng, Sunnyvale, CA (US); Jun Li, Mountain View, CA (US)

(21) Appl. No.: 14/126,583

(22) PCT Filed: Oct. 24, 2011
(86) PCT No.: PCT/US2011/057450

§ 371 Date: Dec. 16, 2013

Related U.S. Application Data
(60) Provisional application No. 61/525,247, filed on Aug. 19, 2011.

(51) Int. Cl. G06Q 10/06

(52) U.S. Cl. CPC G06Q 10/067
USPC 705/348

(57) ABSTRACT

A cloud-based infrastructure provides a simulation service accessible by a plurality of different enterprises. The cloud-based infrastructure executes an operation simulation in response to access of the simulation service by a particular one of the plurality of enterprises, wherein the operation simulation is of a business process of the particular enterprise and uses information provided by the particular enterprise.

### BACKGROUND

An enterprise can engage in a business process (or business processes). Examples of business processes include manufacturing of products such as print artifact manufacturing, promotion of products or services such as a nationwide marketing campaign, sales of products or services, delivery of products or services, and so forth. At some point, an enterprise may decide to implement a change in a business process, which can include increasing or decreasing capacity (in infrastructure, labor, etc.), implementing new systems, policies, or techniques, and so forth.

### BRIEF DESCRIPTION OF THE DRAWINGS

Some embodiments are described with respect to the following figures:

FIGS. 1 and 3 are block diagrams of example arrangements that are able to provide a cloud-based simulation service, according to various implementations;

FIG. 2 is a flow diagram of a process of providing a cloud-based simulation service, according to some implementations;

FIG. 4 is a schematic diagram of a simulation environment according to some implementations; and

FIG. 5 is a block diagram of an example arrangement including multiple computer systems for implementing a cloud-based simulation service infrastructure according to some implementations.

### DETAILED DESCRIPTION

Enterprises, including companies, educational organizations, government agencies, individuals, or other entities, are continually attempting to improve their respective business processes to enhance efficiency, meet increasing demands, reduce costs, increase profits, and so forth. A “business process” is referred to as a process that an enterprise engages in to achieve an objective of the enterprise, such as to provide a deliverable (product or service). A business process can involve use of an enterprise's infrastructure (e.g. computing equipment, storage equipment, manufacturing equipment, communications equipment, etc.), and/or can involve personnel of the enterprise.

A decision made to modify a business process can have various effects, including impact on customers, impact on enterprise personnel, impact on the finances of the enterprise, and/or other impacts. Some effects can be disruptive, such that it may be prudent for an enterprise to carefully determine what such effects of a business process change may be (prior to effecting the business process change). An example of a business process change includes investment in additional or replacement equipment. Prior to making the investment, which can be expensive, the enterprise may wish to first estimate the effect of such investment. Another example of a business process change includes installing new applications or operating systems, hiring new employees, increasing or decreasing inventory, adding a new site, and so forth.

What-if simulations can be performed to determine effects (as part of a cost-benefit analysis, for example) of a business process change. A “what-if simulation” refers to a simulation performed given a particular scenario, where the particular scenario is described by input information provided to a simulation system that performs the what-if simulation. Often, an enterprise uses its own computing resources to perform what-if simulations. Depending on the extent of the business process, extensive processing resources and/or storage resources may have to be provided to perform a what-if simulation. In some cases, an enterprise may not have the requisite resources to perform what-if simulations in a timely manner, and the enterprise may not wish to invest in acquiring the resources.

A simulation of a business process can treat the business process as a series of inter-related activities, where the activities can convert inputs to outputs. The operations of the business process are simulated by stepping through the activities to test out what-if scenarios. The simulation can quantify current operations efficiency for creating a baseline. The simulation can then quantify alternatives (changes) to the business process, so that any financial effects (e.g. cost of goods sold), disruption effects (e.g. site consolidation may result in relocation and layoffs of workers), and/or other effects (e.g. lead time for delivery) can be determined.

In accordance with some implementations, a cloud-based simulation service is provided to allow enterprises to perform what-if simulations. Using the cloud-based simulation service, an enterprise can first simulate a change to a business process and perform a cost-benefit analysis before committing to the change. Simulating “what-if” scenarios and using the simulation to guide decision making can help to reduce the risk of unforeseen consequences, reduce expenditure and avoid disruption, and can lead to better solutions.

The cloud-based simulation service is provided by a cloud-based computing environment, which is managed by a simulation service provider. The cloud-based computing environment includes computing resources, storage resources, tools, and other components that can be shared by multiple entities (e.g. enterprises). The cloud-based computing environment is accessible over a network by entities that are remotely located.

The simulation service provider can provide the simulation service to multiple enterprises. Effectively, the cloud-based simulation service is provided in a multi-tenant cloud-based computing environment, where the multiple tenants are referred to as the multiple enterprises that are able to separately request the simulation service to perform respective operation simulations using individual enterprises' corresponding input data sets and simulation models. The “operation simulations” requested by respective enterprises can include simulations of respective operations of the enterprises. A simulation model can specify one or multiple what-if scenarios that are to be simulated.

By allowing an enterprise to perform a what-if simulation using the resources of the simulation service provider, the enterprise does not have to employ the enterprise's own resources to perform the simulation. Also, the enterprise does not have to hire personnel with expertise to set up simulation systems, which can be complex. The cloud-based simulation service provided by the simulation service provider is able to accommodate relatively complex scenarios in ever-changing situations of the enterprise. The simulation service provider is able to provide sufficient resources (e.g. computing resource, storage resources, tools, expertise, etc.) on demand to accommodate the simulation requests such that the simulation time for a requested simulation service can be shortened.

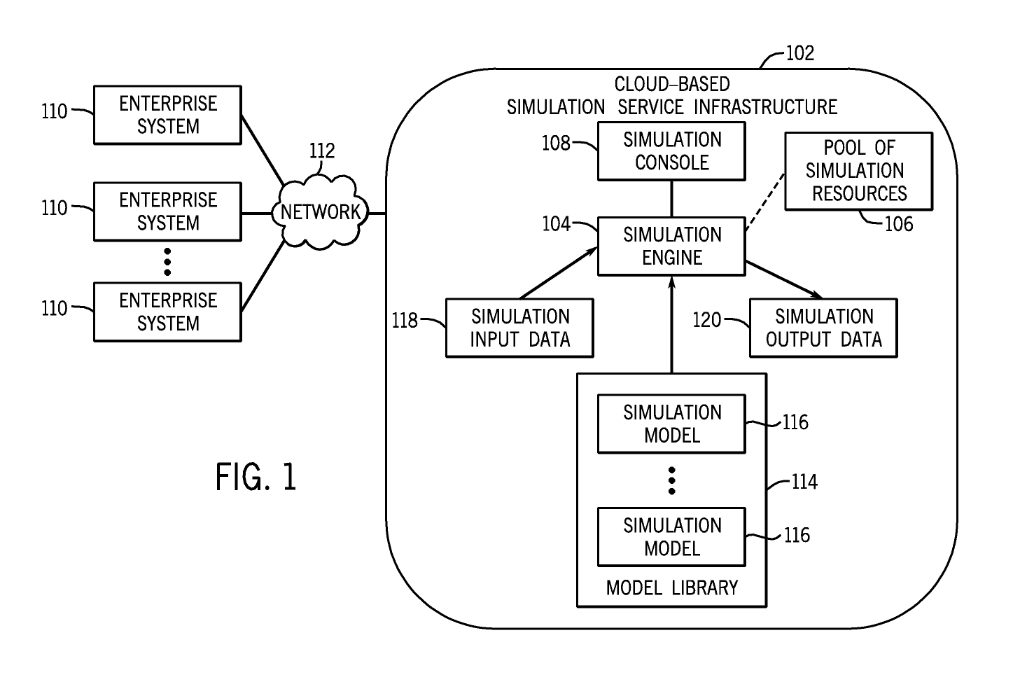

FIG. 1 illustrates an example arrangement that includes a cloud-based simulation service infrastructure 102, which includes various components, including a simulation engine 104 and pool of simulation resources 106. The pool of simulation resources 106 can include physical machines (e.g. processing resources, storage resources, network resources, etc.), virtual machines (virtualized environments in physical machines), tools (e.g. software applications), and so forth. The pool of simulation resources 106 constitutes shared simulation resources that can be used for performing respective different cloud-based simulation services, such as for different requesting enterprises. As noted above, an “enterprise” can be referred to as a company, an educational organization, a government agency, an individual, or any other entity that is able to request performance of a cloud-based simulation service from the cloud-based simulation service infrastructure 102.

The pool of simulation resources 106 can be divided into multiple partitions that are used for respective different cloud-based simulation services. Thus, for example, a first cloud-based simulation service requested by a first enterprise can use a first partition of the pool of simulation resources 106, a second cloud-based simulation service requested by a second enterprise can use a second partition of simulation resources, and so forth.

Generally, the cloud-based simulation service infrastructure 102 allows concurrent execution of business process simulations that can be based on different input data sets and different what-if scenarios. Different simulation environments can be dynamically launched in the cloud-based simulation service infrastructure 102 in response to corresponding accesses of the simulation service by multiple enterprises. Note that access of the simulation service by an enterprise is referred to as access of the simulation service by a user of the enterprise. A user can dynamically launch a private simulation environment with a collection of resources allocated from the shared pool of resources 106. Once the simulation is finished, the simulation environment is terminated and the allocated resources are returned to the pool of resources.

In some examples, the cloud-based simulation service infrastructure 102 can provide security-policy-enforced, isolated access of the simulation service for each requestor (e.g. user, machine, etc.) of a simulation service. Each requestor is entitled to access only the requestor's own simulation artifacts (e.g. simulation model, simulation input data, simulation output data, etc.) and simulation runtime artifacts (e.g. a simulation environment, simulation progress and health monitoring, etc.). By protecting the privacy of a requestor's simulation environment from other requestors, unauthorized access of simulation-related data can be prevented. In this way, from an enterprise's viewpoint, the enterprise is provided with its own private simulation cloud.

The cloud-based simulation service infrastructure 102 also includes a simulation console 108, which is able to present an interface at a corresponding enterprise system 110 to allow for the respective enterprise system to request a cloud-based simulation service. An enterprise system 110 can include any type of electronic device, such as a computer (e.g. desktop computer, notebook computer, tablet computer, etc.), a personal digital assistant (PDA), a smartphone, a server, and so forth. The enterprise systems 110 are able to communicate with the cloud-based simulation service infrastructure 102 over a network 112, which can include a public network (e.g. the Internet, a wireless network, etc.), a private network (e.g. local area network, wide area network, etc.), or some combination thereof.

The cloud-based simulation service infrastructure 102 can be implemented on a server computer or on a distributed arrangement of server computers. The resources of the server computer or distributed arrangement of server computers are part of the pool of simulation resources 106.

The cloud-based simulation service infrastructure 102 also includes a model library 114, which includes simulation models 116 that can be used to perform various simulation services. These simulation models 116 can be models provided by the simulation service provider, to enable “simulation expertise as a service.” Alternatively, a simulation model 116 can be provided by a respective enterprise.

In other examples, the cloud-based simulation service infrastructure 102 can provide a base simulation model to an enterprise, which can then use the base simulation model as a starting point to construct the enterprise's proprietary simulation model for use in performing an operation simulation with the cloud-based simulation service infrastructure 102.

In some examples, each simulation model 116 can be represented by an XML (Extensible Markup Language) file, for example. In other examples, a simulation model can be represented in another format. The model library 116 includes multiple different types of simulation models 116 corresponding to different types of enterprises—an enterprise can leverage this built-in simulation expertise by adopting simulation models that most represent its industry (e.g. marketing industry, manufacturing industry, book printing industry, content fulfillment industry, packaging industry, service industry, etc.), size (e.g. headcount), and other factors. Additionally, each enterprise can elect to share his/her simulation models with the other potential requestors of the cloud-based simulation service infrastructure 102. Once an enterprise registers its simulation model(s) with the infrastructure 102, the enterprise can elect to make the simulation model(s) available to other requestors of the cloud-based simulation service infrastructure 102. In this way, each requestor of a simulation service can access not only the requestor's private simulation models, the simulation models provided by the simulation service provider, but also the simulation models that have published by other requestors.

In some examples, a business process of an enterprise can include a print fulfillment business process, in which the enterprise (a print service provider) can receive an order for print fulfillment, and in response manufactures print artifacts. In such examples, the simulation model can include an order profile (a profile of orders that are received by the print service provider), resource makeup (resources available to the print service provider, such as printing equipment, print substrate inventory, etc.), operating policy (policy governing operation of the print service provider), and order fulfillment paths (paths available for fulfilling orders, such as paths including different printing and finishing equipments).

A model can specify one or multiple what-if scenarios to be simulated. In some examples, the model can describe a simulation scenario of interest, and this scenario can serve as the baseline to populate other models (e.g. other XML files) that represent other respective what-if scenarios.

In further examples, an enterprise can also provide its simulation model to advertise the enterprise's capability to customers of the enterprise; the customer can run this operations simulation model to quantify the possible lead time, cost and other metric that characterizes this enterprise's capability. In some cases, an enterprise may elect to publish its simulation model so that the simulation model is made public. This can allow other users to benefit from the published simulation model.

Additionally, each enterprise can leverage from the enterprise's past simulation expertise, the simulation expertise provided by simulation service provider, as well as the simulation expertise of other enterprises, in some implementations.

FIG. 1 also shows simulation input data 118 that can be provided to the simulation engine 104. The simulation input data 118 includes data provided by an enterprise system 110 for performing a corresponding cloud-based simulation service. The input data 118 provided by an enterprise to perform a respective operation simulation in the cloud-based computing environment can include proprietary data that relates to a business process of the enterprise.

As noted above, in some examples, a business process to be the subject of what-if simulation can include a print manufacturing process. A print manufacturing process can be implemented by a print service provider, and is used to produce print artifacts (e.g. copies of written materials, brochures, marketing collaterals, books, photographs, etc.). In other examples, a business process can include some other type of process.

The output of a simulation service is provided by the simulation engine 104 as simulation output data 120. The simulation output data 120 can be communicated back to the requesting enterprise system 110 over the network 112.

By using the cloud-based simulation service infrastructure 102 according to some implementations, scalable simulations can be provided in a multi-tenant cloud-based computing environment on behalf of multiple enterprises. Each enterprise can manage its own respective different simulation model(s) for use in performing simulation(s).

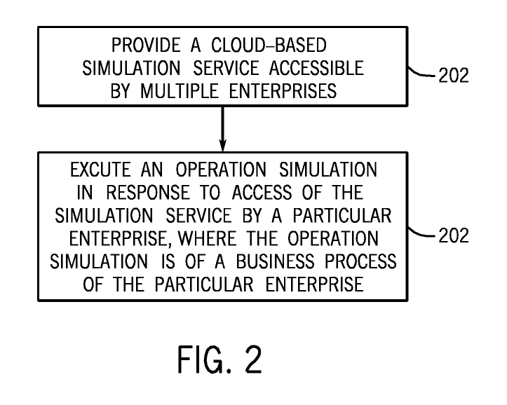

FIG. 2 is a flow diagram of a process according to some implementations. The process can be performed by the cloud-based simulation service infrastructure 102 of FIG. 1. The infrastructure 102 provides (at 202) a cloud-based simulation service that is accessible by multiple enterprises, such as by use of respective enterprise systems 110 in FIG. 1.

The infrastructure 102 executes (at 204) an operation simulation in response to access of the simulation service by a particular one of the multiple enterprises, where the operation simulation is of a business process of the particular enterprise and uses information provided by the particular enterprise. The information provided by the particular enterprise can include the input data 118 and one or multiple simulation models 116 (FIG. 1).

The process of FIG. 2 is repeated for other simulation requests received by the infrastructure 102 from other enterprises.

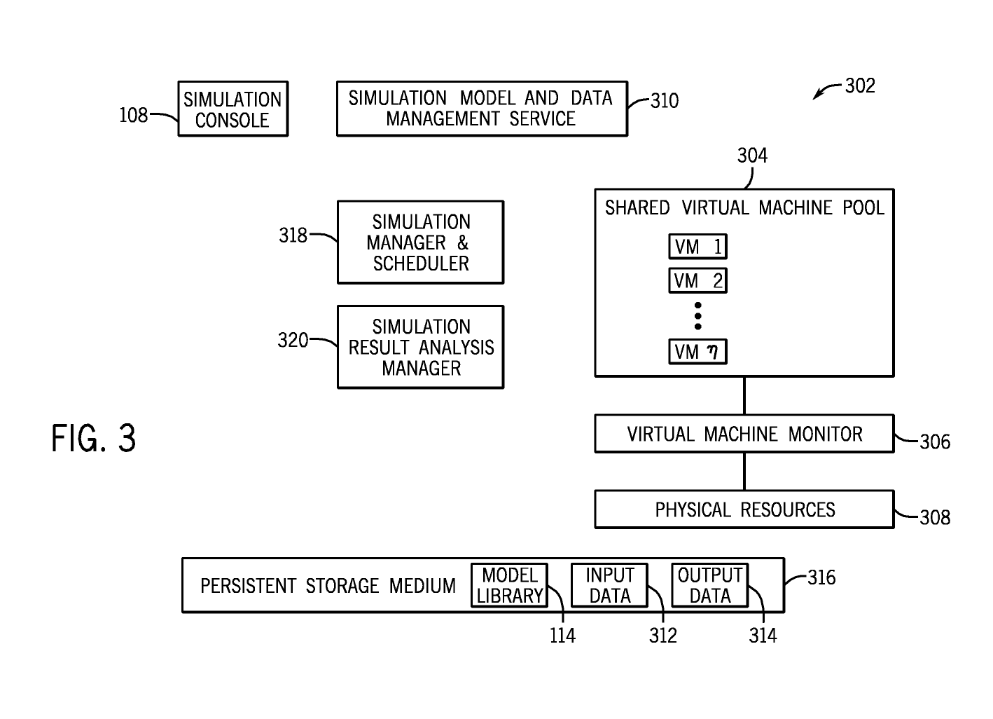

FIG. 3 is a block diagram of a cloud-based simulation service infrastructure 302 according to further implementations. In FIG. 3, the pool of simulation services that can be shared by multiple operation simulations includes a shared virtual machine pool 304, which has virtual machines VM 1, VM 2, . . . , VM n, where n represents a number of virtual machines in the pool 304.

A “virtual machine” (also referred to as a “virtual appliance” or “virtual partition”) refers to some partition or segment of a physical machine or arrangement of physical machines. From the perspective of a user or application, a virtual machine looks like a physical machine. A virtual machine includes an operating system (referred to as a guest operating system) and at least one application program.

A virtual machine monitor (VMM) 306, also referred to as a hypervisor, manages the sharing, by the virtual machines, of the physical resources 308, including the hardware components (e.g. processor(s), memory device(s), network interface controller(s), input/output device(s), and so forth), of the system that makes up the cloud-based simulation service infrastructure 302. The VMM 306 virtualizes the physical resources. Each virtual machine has associated virtualized physical resources managed by the VMM. The VMM processes requests for physical resources.

Although reference is made to virtual machines as being the pool of resources that are being shared for provision of simulation services, in alternative implementations, different types of resources can be shared. For example, the pool 304 can be a pool of physical machines that can be allocated to perform simulation services.

In some examples, the cloud-based simulation service can be exposed to potential requestors of simulation services by use of a set of service APIs (application programming interfaces). The set of service APIs can allow modules, such as business analytic modules or other modules, to access the simulation service.

The cloud-based simulation service infrastructure 302 of FIG. 3 also includes a simulation model and data management service 310. A requestor of a simulation service can input a simulation model to the simulation model and data management service 310. The simulation model can be in the form of an XML file, for example, or can be in another format. Simulation models can be kept in the model library 114 (discussed above), which can be stored in a persistent storage medium (or media) 316. The simulation model and data management service 310 can also specify where input data 312 for a simulation is located, and where output data 314 is to be stored, in the persistent storage medium or media 316.

A simulation definition provided by a simulation model can define one or multiple simulation scenarios. In examples where a simulation model defines multiple simulation scenarios, each of the simulation scenarios can take the same simulation input data, and produce different simulation outputs that are to be stored in the designated data output location (e.g., a file in a file directory).

In some examples, a simulation model can also include an analysis code package, which can be invoked to analyze simulation results produced from a simulation. In some examples, the analysis code package can be in the form of a Java servlet—in other examples, the analysis code package can be in a different form.

The simulation model and data management service 310 can also perform requestor identity management for supporting a multi-tenant environment. Requestor identity management involves authenticating requestors (based on credentials of the requestors) and restricting access to simulation-related assets (e.g. simulation model, input data, output data, etc.). Requestor identity management also prevents unauthorized access of a simulation environment associated with a particular requestor. Also, the simulation model and data management service 310 can ensure that just the requestor is able to perform analysis on the output data of a simulation.

The cloud-based simulation service infrastructure 302 of FIG. 3 also includes a simulation manager and scheduler 318 (the simulation manager and scheduler 318 can be considered a part of the “simulation engine” in some examples). The simulation manager and scheduler 318 can accept a simulation start or shutdown command from a requestor, and can correspondingly launch the simulation service using the shared virtual machine pool 304, or can shut down the simulation run and return the allocated virtual machine(s) to the pool 304.

In response to a simulation start command (along with the specified simulation model to be run), the simulation manager and scheduler 318 determines an allocation of the virtual machines in the pool 304 for fulfilling the requested simulation within an expected time frame. The allocation of resources can be one virtual machine, or multiple virtual machines. The allocated virtual machine(s) form(s) a simulation virtual machine cluster, and each virtual machine in the cluster can be populated with the corresponding simulation model-specific code. This code (referred to as “simulation code”) can be executed in the allocated virtual machine(s) to perform the simulation. Once the simulation cluster is constructed, the simulation can be started by the simulation manager and scheduler 318. In some examples, the simulation manager and scheduler 318 is also responsible for monitoring the health of the simulation cluster. If a virtual machine in the cluster were to fail during the simulation, a new virtual machine can be requested and allocated to the cluster to replace the failed virtual machine.

In some implementations, when starting a requested simulation, the simulation manager and scheduler 318 can produce a launching script (for launching a simulation environment) and a shutdown script (for shutting down the simulation environment and returning allocated resources to the pool 304). A launching script is able to interact with the VMM 306 to request an allocation of virtual machines for the requested simulation. If the simulation involves multiple simulation scenarios, then multiple respective virtual machines can be assigned.

In some examples, virtual machines allocated to a simulation can be divided into multiple tiers. A launching script can assign allocated virtual machines to multiple different tiers, including a web server tier, a simulation engine tier, and a database tier. The web server tier allows for web-based interaction with a requestor. The simulation engine tier performs the simulation tasks. The database tier is for retrieving and storing data (such as retrieving input data and storing output data of the simulation).

A simulation is performed in a simulation session, which begins at the time a simulation run is started by a requestor, and ends at a time when a simulation run is finished and terminated by the requestor. Different information can be recorded in a session tracking data structure (e.g. a table), such as an identity of the requestor, simulation design information (a simulation model, input data, output data, and the analysis code package), the allocated virtual machines, and so forth.

Once the simulation environment is formed and the simulation run is started, each virtual machine involved in the simulation can be monitored for the health of the virtual machine. As noted above, this monitoring can be performed by the simulation manager and scheduler 318. In some examples, the simulation manager and scheduler 318 can intermittently poll the virtual machines involved in a simulation-a successful response indicates good health of the polled virtual machine, while an unsuccessful response (or lack of a response) indicates a faulty or failed virtual machine.

In addition, the simulation manager and scheduler 318 can monitor progress of a simulation. The simulation code that is executed to perform a simulation can intermittently provide a status update of its progress (e.g. what percentage of the simulation has been completed). The progress information can be gathered, and can be sent to the simulation requestor, either automatically or in response to a request for the progress information.

Once a simulation is completed, the analysis code package of the respective simulation model can be invoked (either manually or automatically) to perform analysis of the simulation output data. In some examples, a simulation result analysis manager 320 is able to interact with the VMM 306 or another entity to allocate a virtual machine for the simulation result analysis, and to populate the analysis code package in the virtual allocated machine. The launched analysis code package is then able to communicate with the requestor to start the analysis of the simulation output data, and to navigate through analysis results.

In some examples, there can be an online analysis mode and an offline analysis mode. The online analysis mode performs simulation result analysis while the corresponding simulation is still running. The offline analysis mode is conducted on the simulation output data after the simulation has finished.

To support online analysis, the analysis code package can be provided to a virtual machine in a web server tier. Based on the session tracking table discussed above for the corresponding simulation session, the analysis code package is aware of where the simulation output data is located in the database tier, based on the simulation environment information stored for the corresponding simulation.

To support offline analysis, a number of persistent simulation sessions can be maintained. One particular persistent simulation session can be chosen to run an offline simulation analysis. From the corresponding session tracking table, the simulation manager and scheduler 318 is able to locate the simulation artifacts (model, input data, output data, requestor credentials, etc.), and correspondingly can produce and run a launching script to launch an offline simulation analysis environment.

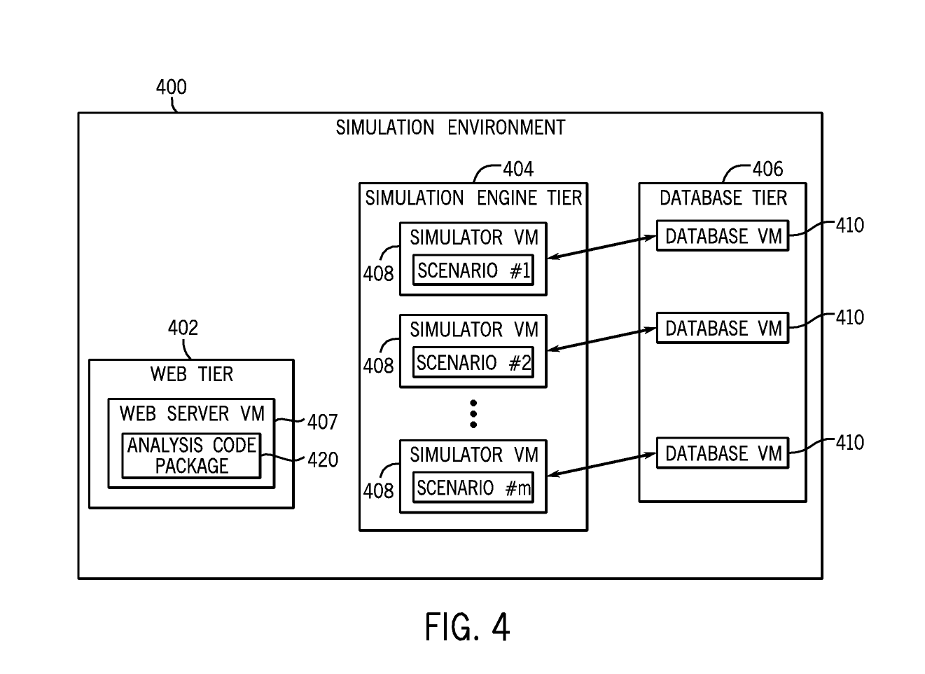

A multi-tier simulation environment 400 for a particular simulation session is shown in FIG. 4. As noted above, the simulation environment can include three tiers, including a web tier 402, a simulation engine tier 404, and a database tier 406. Each of the tiers can include a respective subset of one or multiple allocated virtual machines (allocated from the virtual machine pool 304 of FIG. 3). The web tier 402 includes a web server virtual machine 407. In some examples, as noted above, an analysis code package 420 can be executed in the web server virtual machine 407 to perform online analysis of simulation results.

In examples according to FIG. 4, the simulation engine tier 404 includes simulator virtual machines 408 for simulating different scenarios (scenario #1, scenario #2, . . . , scenario #m). The database tier 406 includes database virtual machines 410 associated with corresponding ones of the simulator virtual machines 404. Each database virtual machine 410 controls the access of input data and output data for the corresponding simulation scenario.

In other examples, instead of providing one-to-one correspondence between simulator virtual machines 408 and database virtual machines 410, there can be a different number of database virtual machines 410 than there are simulator virtual machines.

As noted above, security can be provided in the cloud-based simulation service infrastructure 302 to protect simulation-related artifacts relating to a simulation requested by a requestor. A launching script to launch a simulation simulator environment is run on behalf of the requestor. As the result, the launching script is tied to the corresponding requestor credential. When a launching script is run to allocate virtual machines from the pool 304 of FIG. 3, the requestor credential can be presented to the VMM 306; as a result, the VMM 306 is able to ensure that shutdown of the allocated virtual machines can just be requested shutdown by the same requestor.

Additionally, a virtual machine in the database tier (e.g. 406 in FIG. 4) can request, receive and validate the requestor credential, to ensure that access to input data and output data of the simulation is controlled by the database virtual machine. A simulator virtual machine in the simulation engine tier (e.g. 404 in FIG. 4) is also provided with the requestor credential to allow access by just the requestor. Furthermore, just the simulator virtual machines within the same simulation environment are allowed to access the corresponding database virtual machines.

Also, the web server virtual machine in the web tier (e.g. 402 in FIG. 4) is accessible by just the requestor with the correct credential. The requestor is authenticated by the web server virtual machine before access granted to the requestor, such as to access analysis results of the simulation output data.

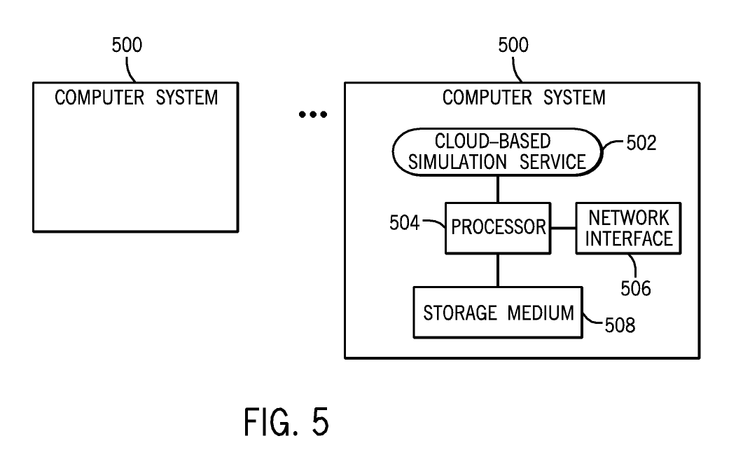

FIG. 5 shows an example arrangement computer systems 500 that can be used to implement the cloud-based simulation service infrastructure 102 or 302 of FIG. 1 or 3. Although multiple computer systems 500 are shown in FIG. 5, there can be just one computer system 500 in other examples. Each computer system 500 includes a cloud-based simulation service 502, which can include the various components depicted in FIG. 1 or 3.

The cloud-based simulation service 502 is executable on a processor (or multiple processors) 504. A processor can include a microprocessor, microcontroller, processor module or subsystem, programmable integrated circuit, programmable gate array, or another control or computing device.

The computer system 500 also includes a network interface 506 to perform network communications, such as with other computer systems 500 and/or with requestors. The computer system 500 also includes a storage medium 508 (or storage media) to store data.

The storage medium or media 508 can be implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
providing, by a cloud-based infrastructure, a simulation service accessible by a plurality of different enterprises; and
executing, in the cloud-based infrastructure, an operation simulation in response to access of the simulation service by a particular one of the plurality of enterprises, wherein the operation simulation is of a business process of the particular enterprise and uses information provided by the particular enterprise.

2. The method of claim 1, wherein executing the operation simulation comprises executing a what-if scenario simulation of the business process.

3. The method of claim 2, wherein executing the what-if scenario simulation comprises executing the what-if scenario simulation to determine an effect to the enterprise due to a potential change to be made to the business process.

4. The method of claim 1, wherein executing the operation simulation comprises executing the operation simulation of a print manufacturing process.

5. The method of claim 4, wherein executing the operation simulation of the print manufacturing process comprises executing the operation simulation of the print manufacturing process that produces print artifacts.

6. The method of claim 1, further comprising dynamically launching different simulation environments in the cloud-based computing environment in response to corresponding accesses of the simulation service by multiple ones of the plurality of enterprises.

7. The method of claim 6, wherein each of the simulation environments includes a respective set of resources selected from among virtual machines and physical machines.

8. The method of claim 6, wherein at least two of the simulation environments are isolated from each other.

9. The method of claim 1, further comprising providing, in the cloud-based infrastructure, models of different types from which a model is selectable by a given enterprise for adoption as the model to use in a respective simulation of a business process of the given enterprise.

10. A system comprising:
a cloud-based infrastructure having resources to provide a simulation service accessible by a plurality of enterprises,
wherein the cloud-based infrastructure includes a simulation engine to execute an operation simulation in response to access of the simulation service by a particular one of the plurality of enterprises, wherein the operation simulation is of a business process of the particular enterprise and uses information provided by the particular enterprise.

11. The system of claim 10, wherein the information provided by the particular enterprise includes a simulation model defining a what-if scenario for simulation.

12. The system of claim 10, wherein the resources of the cloud-based infrastructure includes virtual machines or physical machines that are to be dynamically allocated to perform the operation simulation.

13. The system of claim 10, wherein the resources of the cloud-based infrastructure include multiple tiers of resources the multiple tiers including a web tier, a simulation engine tier, and a database tier.

14. The system of claim 10, wherein the cloud-based infrastructure is to associate a credential with a requestor of the simulation service to protect simulation artifacts associated with the requestor.

15. An article comprising at least one machine-readable storage medium storing instructions that upon execution cause a system to:
provide, by a cloud-based infrastructure in the system, a simulation service accessible by a plurality of different enterprises; and
execute, in the cloud-based infrastructure, an operation simulation in response to access of the simulation service by a particular one of the plurality of enterprises, wherein the operation simulation is of a business process of the particular enterprise and uses information provided by the particular enterprise.
